(19) United States
(12) Patent Application Publication
(10) Pub. No.: US 2005/0223746 A1
(43) Pub. Date: Oct. 13, 2005

(54) Method and apparatus for producing a tempered glass sheet by forced cooling

(76) Inventors: Hideo Yoshizawa, Osaka (JP); Kazunori Yuuki, Osaka (JP); Hiroaki Kato, Osaka (JP); Eiichi Nakaoka, Osaka (JP)

Correspondence Address: MERCHANT & GOULD PC, P.O. BOX 2903, MINNEAPOLIS, MN, 55402-0903, US

(21) Appl. No.: 10/515,105

(22) PCT Filed: Jul. 16, 2003
(86) PCT No.: PCT/JP03/09047

§ 371 Date: Nov. 19, 2004

(30) Foreign Application Priority Data
Jul. 17, 2002 (JP) 2002-208327

(51) Int. Cl. C03B 27/00

(52) U.S. Cl. 65/114; 65/115; 65/349

(57) ABSTRACT

A forced cooling apparatus (1) for use in the production of a tempered glass sheet includes an air-quench unit (9) for blasting cooling air against opposite surfaces of a glass sheet to quench the glass sheet, the glass sheet having been heated at a predetermined temperature, and a contact quenching unit (10) disposed downstream of the air-quench unit and equipped with a water-retentive member wet with water, the contact quenching unit being operative to cause the water-retentive member to contact the opposite surfaces of the glass sheet to further quench the glass sheet. Also disclosed are a tempered glass sheet producing method in which the forced cooling apparatus may be used and a tempered sheet glass which is produced by using a modified form of the contact quenching unit are also disclosed.

### TECHNICAL FIELD

The present invention relates generally to the production of tempered glass sheets, and more particularly to a method of producing a tempered glass sheet, a forced cooling apparatus for use in such method, and a tempered glass sheet produced by using the forced cooling apparatus.

### BACKGROUND ART

Heretofore, physically strengthened or tempered glass sheets are produced chiefly by a so-called “air-quench tempering process” in which a glass sheet is heated just below its softening point (e.g., 650° C.) and then jets of cooling air blast the surface of the heated glass sheet to rapidly cool or quench the glass sheet surface to thereby form a compressive layer on the surface.

Another known tempering method is a water mist quenching process, which is disclosed, for example, in Japanese Patent Laid-Open Publication No. SHO-58-109832 entitled “Glass Sheet Tempering Method” and Japanese Patent Laid-Open Publication No. SHO-61-58827 entitled “Method of Producing Tempered Glass Lids”. Japanese Patent No. 2766355 entitled “Apparatus for Bending and Quenching Glass Sheet” shows still another tempering method called “solid contact quenching process”.

As for vehicular windshields, there is an increasing demand for thin glass sheets to meet the recent requirement for vehicles to be light in weight. The term “thin glass sheets” used herein is intended to refer to those glass sheets having thicknesses not greater than 3.0 mm.

The thin glass sheets could hardly have a temperature difference between the center and the surface thereof upon air quenching. Thus, the conventional air-quench tempering process for such thin glass sheets is limited even through the speed and quantity of cooling air are increased by using a blower of higher pressure and capacity. Furthermore, use of such high-power blower would incur additional electricity expense and generate higher operation noise.

Alternatively, a water quenching process may be employed for its extremely high cooling capacity. A problem occurs, however, that due to an extremely large tensile stress momentarily created on the glass sheet surface at the initial stage of quenching, the chance of occurrence of glass sheet breakage is relatively high.

It is accordingly an object of the present invention to provide a forced cooling technique which is suitable for the production of a tempered glass sheet having a higher level of strength or toughness than those obtained by the conventional air-quench tempering process and also is capable of effectively achieving quench-tempering of thin glass sheets.

### DISCLOSURE OF THE INVENTION

According to a first aspect of the present invention, there is provided a method of producing a tempered glass sheet, comprising: a primary quenching step in which a glass sheet heated at a predetermined temperature is quenched by blasting a cooling air against opposite surfaces of the glass sheet; and a secondary quenching step in which the glass sheet, which has been subjected to the primary quenching step, is further quenched by causing a water-retentive member to contact the opposite surfaces of the glass sheet with water retained in the water-retentive member.

In the tempered glass producing method of the present invention, the conventional air-quench process is used as the primary quenching step. The air-quench process quenches the heated glass sheet with such a cooling capacity that the glass sheet is not damaged or broken due to thermal shock at the initial stage of quenching. A tensile stress temporarily created on the glass sheet surface at the initial stage of quenching is, therefore, limited to the extent that breakage does not occur in the glass sheet. Thus, the glass sheet breakage at the initial stage of quenching can be avoided.

The primary quenching step is followed by the secondary quenching step which employs a contact quenching process using a water-retentive member (hereinafter may be referred to as “water-retentive member contact quenching process”). The contact quenching process quenches the glass sheet with a high cooling capacity which is capable of performing thermal-strengthening or tempering of the glass sheet while keeping a large temperature difference between the surface and the center of the glass sheet. This insures that even the thin glass sheet can be effectively tempered. Furthermore, for the glass sheets with thicknesses not less than 3.0 mm, a higher level of toughness can be obtained.

The air-quenching process achieved as the primary quenching step may last for at least 1.0 second because after such period, the tensile stress temporarily created on the glass sheet surface at the initial stage of quenching passes its peak and decreases gradually. This means that breakage does not occur even when the glass sheet is subjected to a subsequent severe quenching process, such the water-retentive member contact quenching process having high cooling power or capacity. Thus, the tempered glass sheet can be produced on a commercial basis.

In the water-retentive member contact quenching process, a water-retentive member wetted with water, such as a fabric suitably wetted with water, is forced against the glass sheet to thereby quench the surface of the glass sheet. In this process, water in the water-retentive member partly evaporates owing to the heat of the glass sheet, and the glass sheet is thereby effectively cooled by the heat of evaporation (the sum of the latent heat and the sensible heat) of that water.

The water-retentive member contact quenching process has a cooling capacity which is intermediate between the cooling capacity of the air-quench process and the cooling capacity of a water-quench process where a heated glass sheet is brought into direct contact with cooling water. The water-retentive member contact quenching process is, therefore, able to avoid the occurrence of thermal shock more effectively than the water-quench process. However, when a glass sheet heated to a temperature just below its softening point is directly subjected to the water-retentive member contact quenching process, the water-retentive member contact quenching process, due to its higher cooling capacity than the air-quench process, fails to suppress the tensile stress temporarily created on the glass sheet surface at the initial stage of quenching, allowing breakage to occur in the glass sheet. Even when the glass sheet breakage does not occur, a deteriorated surface layer called “staining” would result from contact of water with the surface of the glass sheet.

It is preferable that the primary quenching step lasts for no longer than (t²/4) seconds where t is a thickness of the glass sheet.

According to a second aspect to the present invention, there is provided a forced cooling apparatus for use in the production of a tempered glass sheet, the forced cooling apparatus comprising: an air-quench unit for blasting cooling air against opposite surfaces of a glass sheet to quench the glass sheet, the glass sheet having been heated at a predetermined temperature; and a contact quenching unit disposed downstream of the air-quench unit and equipped with a water-retentive member wetted with water, the contact quenching unit being operative to cause the water-retentive member to contact the opposite surfaces of the glass sheet to further quench the glass sheet.

In the forced cooling apparatus, the heated glass sheet is quenched first by the air-quench unit whose cooling capacity is not extremely high. This makes it possible to limit the tensile stress temporarily created on the glass sheet surface at the initial stage of quenching to the extent that breakage does not occur in the glass sheet. Thus, the glass sheet breakage at the initial stage of quenching can be avoided. The air-quench unit having such a limited cooling capacity cannot provide a sufficiently large temperature difference between the center and the surface of the glass sheet to effect tempering. To deal with this problem, the forced cooling apparatus of the present invention includes a contact quenching unit equipped with a water-retentive member disposed downstream of the air-quench unit. By thus providing the water-retentive member contact quenching unit, tempering of the glass sheet can be effectively achieved while keeping a sufficiently large temperature difference between the center and the surface of the glass sheet. As a result, even thin glass sheets having a thickness of at most 3.0 mm or less can be well tempered. In addition, a higher level of toughness can be imparted to the glass sheet having a thickness greater than 3.0 mm.

Preferably, the water-retentive member contact quenching unit includes an upper water-retentive member and a lower water-retentive member for holding the glass sheet therebetween, the upper and lower water-retentive members being formed from a material capable of absorbing and storing water, an upper water supply device for supplying water to the upper water-retentive member, and a lower water supply device for supplying water to the lower water-retentive member.

With this arrangement, the glass sheet to be processed is held between the upper water-retentive member and the lower water-retentive member, both wetted with water, and is thereby forcedly cooled or quenched by the upper and lower water-retentive members. The upper water supply device and the lower water supply device act to supply water to the upper water-retentive member and the lower water-retentive member, respectively.

The two water-retentive members wetted with water, such as fabrics suitably wetted with water, are applied to the glass sheet to thereby quench the opposite surfaces of the glass sheet. Thus, water in the water-retentive member partly evaporates owing to the heat of the glass sheet, and the glass sheet is thereby effectively cooled by the heat of evaporation of that water.

In one preferred form of the present invention, the upper water-retentive member is an upper endless belt circulating for contact with an upper surface of the glass sheet, and the lower water-retentive member is a lower endless belt circulating for contact with a lower surface of the glass sheet. The upper water supply device includes an upper water tank in which the upper belt is immersed as it travels along an upper circulating path, and the lower water supply device includes a lower water tank in which the lower belt is immersed as it travels along a lower circulating path. The upper and lower belts, as they pass through the corresponding water tanks, absorb and store water. The water tanks are simple in construction and, hence, the water supply devices as a whole can be manufactured less costly.

In another preferred form of the present invention, the upper water-retentive member comprises a series of upper rolls arranged for contact with an upper surface of the glass sheet and the lower water-retentive member comprises a series of lower rolls arranged for contact with a lower surface of the glass sheet. The upper water supply device comprises a plurality of water supply pipes associated with the respective upper rolls for supplying water to the upper rolls, and a plurality of upper intermediate rolls disposed between the respective upper rolls and the respective water supply pipes and held in rolling contact with the respective upper rolls for controlling the water content of the upper rolls. The lower water supply device comprises a plurality of water tanks disposed directly below the respective lower rolls for holding water therein, and a plurality of lower intermediate rolls partly immersed in the respective water tanks and held in rolling contact with the respective lower rolls for supplying water from the water tanks to the lower rolls while controlling the water content of the lower rolls.

At least one of the upper belt and the lower belt may have an opening formed therein to avoid contact between the glass sheet and water held in the at least one belt to thereby form a less-tempered portion in the glass sheet.

According to still another aspect of the present invention, there is provided a tempered glass sheet having a less-tempered portion formed by processing a glass sheet heated at a predetermined temperature on the forced cooling apparatus of the foregoing construction wherein at least one of the upper belt and the lower belt has an opening formed therein to avoid contact of the glass sheet with the water held in the at least one belt to thereby form a less-tempered portion in the glass sheet.

In general, the tempered glass sheet fractures into small, relatively harmless pieces when broken. If the glass sheet is less-tempered (or temperted to have a lower level of toughness), it will shatter into relatively large shards instead of fracturing into small pieces. Taking this into account, the present invention is intended to positively provide a portion less tempered than the rest of the glass sheet. The less-tempered portion can be used as a name plate or label in which various sorts of information including lot number of the tempered glass sheet are indicated. This application is particularly advantageous because the less-tempered portion can retain its original shape and configuration when the tempered glass sheet is broken, allowing the user to determine the information about the broken tempered glass sheet based on indications given on the less-tempered portion.

### BRIEF DESCRIPTION OF THE DRAWINGS

FIG. 1A is a block diagram showing the general arrangement of a forced cooling apparatus according to a first embodiment of the present invention;

FIG. 1B is a block diagram similar to FIG. 1A, but showing the general arrangement of a forced cooling apparatus according to a second embodiment of the present invention;

FIG. 1C is a block diagram similar to FIG. 1A, but showing the general arrangement of a forced cooling apparatus according to a third embodiment of the present invention;

FIG. 2 is a diagrammatical view, with parts shown in cross section, of the forced cooling apparatus shown in FIG. 1A;

FIG. 3 is an enlarged view of a portion of the forced cooling apparatus shown in FIG. 2, including a contact quenching unit equipped with water-retentive quenching belts;

FIG. 4 is an enlarged view of a portion of FIG. 3, showing the manner in which steam is allowed to vent from the contact quenching unit and the water-retentive quenching bents are supplied with water;

FIG. 5 is a view similar to FIG. 3, but showing a contact quenching device equipped with water-retentive quenching rolls;

FIG. 6 is a perspective view showing a part of a water-retentive quenching belt formed with an aperture;

FIG. 7A is a diagrammatical view of a tempered glass sheet formed by using the apertured water-retentive quenching belt shown in FIG. 6;

FIG. 7B is a view similar to FIG. 7A, but showing the tempered glass sheet with marks or characters provided on a less-tempered portion of the tempered glass sheet; and

FIG. 7C is a view showing the manner in which the tempered glass sheet of FIG. 7B is broken.

### BEST MODE FOR CARRYING OUT THE INVENTION

Certain preferred embodiments of the present invention will be described below in greater detail with reference to the accompanying drawings.

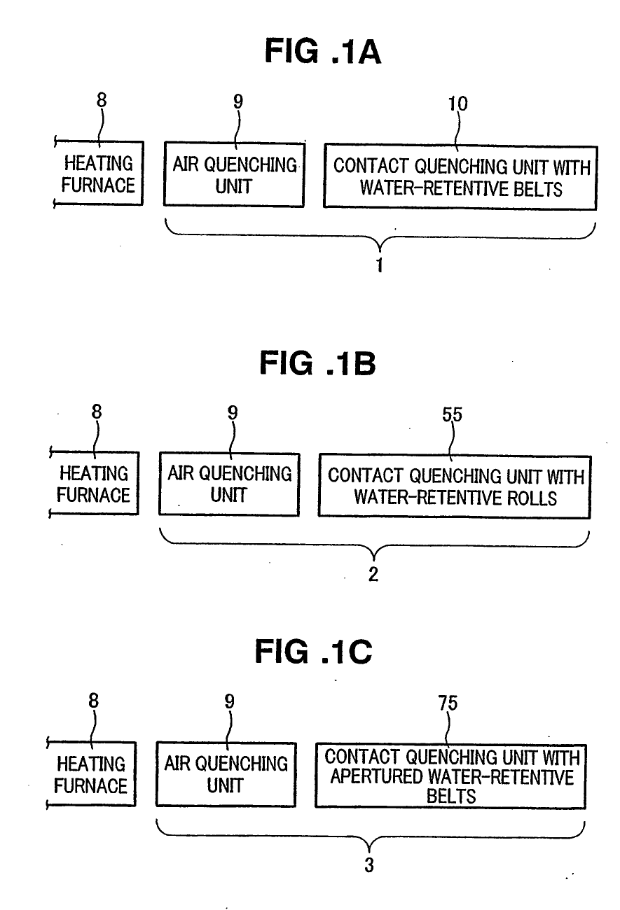

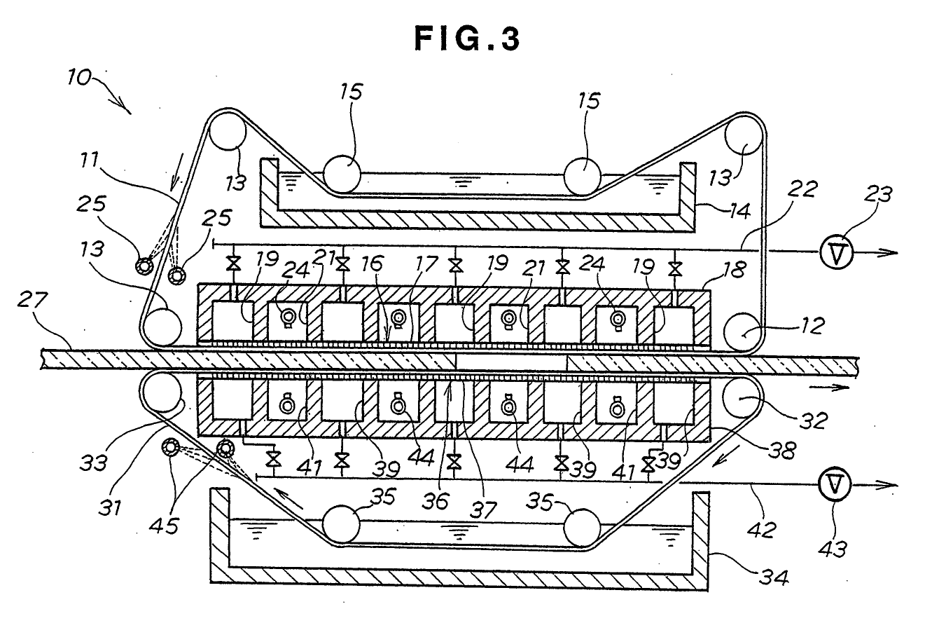

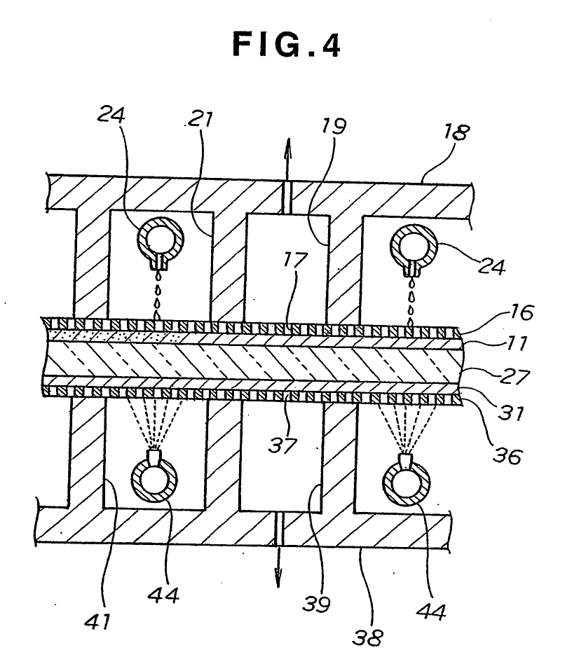

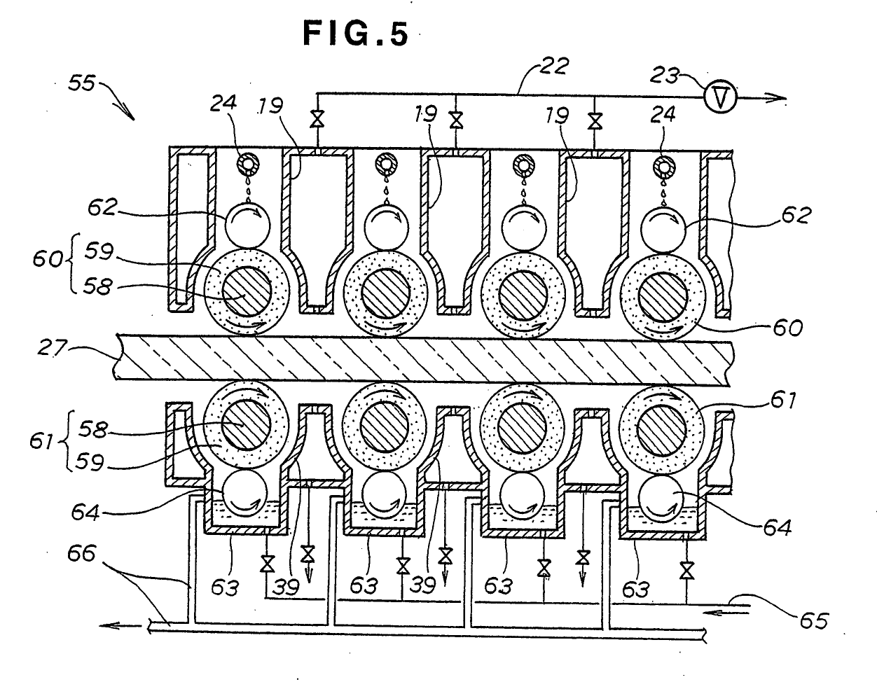

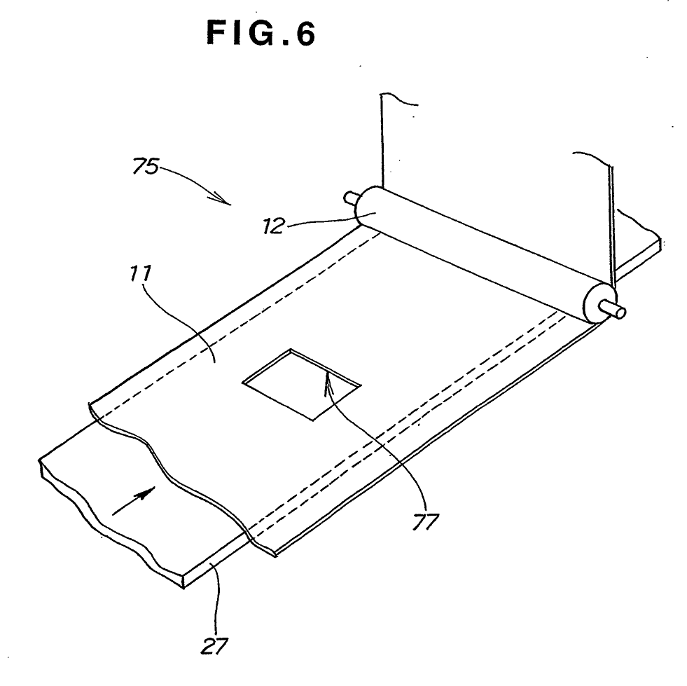

FIGS. 1A, 1B and 1C show in block diagram preferred forms of a forced cooling apparatus according to the present invention. In a first embodiment shown in FIG. 1A, the forced cooling apparatus 1 comprises an air-quench unit 9 and a contact quenching unit 10 disposed downstream of the air-quench unit 9. The contact quenching unit 10 is equipped with water-retentive quenching belts, as will be described in greater detail with reference to FIGS. 3 and 4. In a second embodiment shown in FIG. 1B, the forced cooling apparatus 2 has a contact quenching unit 55 disposed downstream of an air-quench unit 9. The contact quenching unit 55 is equipped with water-retentive quenching rolls, as will be described in greater detail with reference to FIG. 5. In a third embodiment shown in FIG. 1C, the forced cooling apparatus 75 comprises an air-quench unit 9 and a contact quenching unit 75 disposed downstream of the air-quench unit 9. The contact quenching unit 75 is equipped with water-retentive quenching belts at least one of which has an aperture or opening for a purpose described below in greater detail with reference to FIG. 6. In the foregoing embodiments, the air-quench unit 9 is disposed downstream of a heating oven or furnace 8. Though not shown, a forming apparatus may be disposed between the heating furnace 8 and the air-quench unit 9 for forming or bending a flat glass sheet into a desired curvature.

In the heating furnace 8 shown in FIG. 1A, a glass sheet is heated to a predetermined temperature. The air-quench unit 9 of the forced cooling apparatus 1 is disposed immediately downstream of the heating furnace 8 and is designed to direct cooling air against opposite surfaces of the heated glass sheet to thereby cool or quench the glass sheet. The contact quenching unit 10 of the forced cooling apparatus 1 is disposed immediately downstream of the air-quench unit 9 and further quenches the glass sheet via direct contact between the glass sheet and the water-retentive quenching belts.

The air-quench unit 9 serves as a primary quenching unit of the forced cooling apparatus 1 and is constructed to perform forced cooling or quenching of a heated glass sheet with cooling power or capacity that can avoid breakage of the glass sheet which would otherwise occur due to thermal shock. However, a long time quenching by the air-quench unit 9 is not preferable because it may result in a glass sheet excessively cooled down as a whole before being subjected to the secondary quenching process of greater cooling power or capacity. Due to an insufficient temperature difference created between the center and the surface of the glass sheet, effective tempering of a thin glass sheet (with thickness less than 3.0 mm) cannot be achieved even when the second quenching process is conducted. For the same reason, a higher level of toughness cannot be imparted to the glass sheet having a thickness greater than 3.0 mm.

Various experiments conducted for the air-quench unit (primary quenching unit) 9 used in combination with the contact quenching unit (secondary quenching unit) 10 show that the primary quenching process should preferably last for not longer than (t²/4) seconds where t is a thickness of the glass sheet. For instance, when t=2.1 mm, the primary quenching process lasts for not longer than 1.1 seconds. Similarly, for t=3.0 mm, not longer than 2.25 seconds are given to the primary quenching process. When t=6.0 mm, the primary quenching process lasts for not longer than 9.0 seconds.

If the quenching time in the primary quenching process is excessively short, the occurrence of thermal shock cannot be avoided and staining of the glass sheet surface may occur when the glass sheet is treated with the secondary quenching process which is achieved in the contact quenching unit 10 equipped with the water-retentive quenching member. The quenching time in the primary quenching process should preferably be at least longer than a time period during which a tensile stress temporarily created on the glass sheet surface at the initial stage of quenching has passed its own peak. Stated more concretely, the quenching time in the primary quenching process is about 1.0 second though it may depend on the thickness of the glass sheet to be tempered.

On the other hand, an excessively long quenching time in the primary quenching process would result in insufficient tempering of a glass sheet when the glass sheet has a thickness not greater than 3.0 mm and also result in a glass sheet with insufficient level of toughness when the glass sheet is thicker than 3.0 mm. The quenching time in the primary quenching process is preferably not in excess of (t²/6) seconds.

The length of the air-quench unit 9 and the speed of conveyance of the glass sheet may be determined on the basis of the relationship established between the thickness of the glass sheet to be tempered and the quenching time in the primary quenching process achieved by the air-quench unit 9.

Similarly, the forced cooling apparatus 3 shown in FIG. 1C comprises an air-quench unit 9 constructed to rapidly cool or quench a glass sheet by blasting cooling air against opposite surfaces of the glass sheet which has been heated to a predetermined temperature in the heating furnace 8, and a contact quenching unit 75 disposed downstream of the air-quench unit 9 and equipped with water-retentive belts arranged for face-to-face contact with the opposite surfaces of the glass sheet to further quench the glass sheet. At least one of the water-retentive belts has an aperture or opening for a purpose described later.

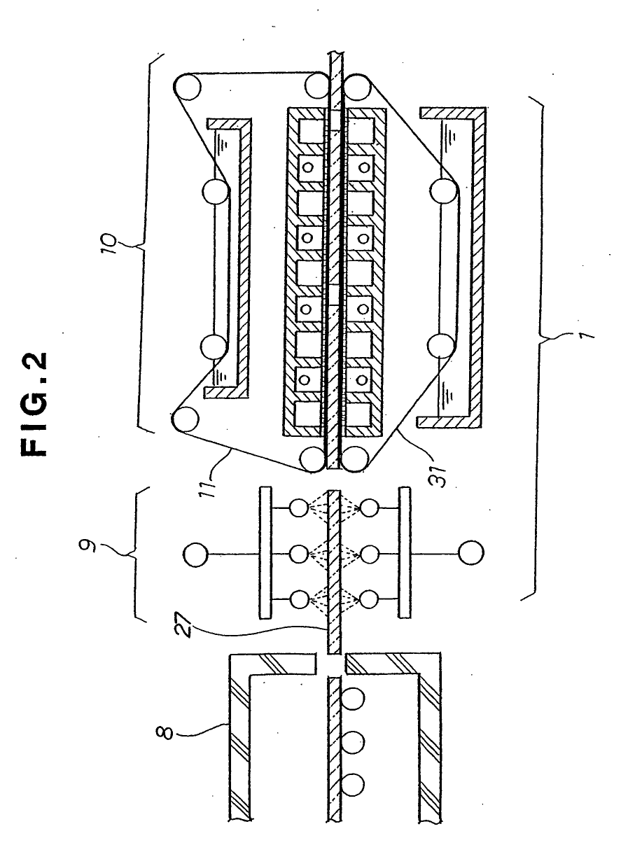

FIG. 2 is a diagrammatical view, with parts shown in cross section, of the forced cooling apparatus 1 shown in FIG. 1A. In the forced cooling apparatus 1, the air-quench unit 9 for blasting cooling air against the opposite surfaces of the heated glass sheet 27 to quench the heated glass sheet and the contact quench unit 10 equipped with the water-retentive belts arranged for face-to-face contact with the opposite surfaces of the glass sheet 27 to further quench the glass sheet 27 are disposed in the order named when viewed in a direction of conveyance of the glass sheet 27. Stated in other words, the contact quenching unit 10 is disposed downstream of the air-quench unit 9. Though not shown, the air-quench unit 9 includes a series of rollers drivable to feed the glass sheet 27 downstream while carrying thereon the glass sheet 27. The air-quench unit 9 has a number of nozzles (not designated) arranged to jet or blast cooling air against opposite surfaces of the glass sheet 27

The heating furnace 8 and the air-quench unit 9 are respectively the same as those of the prior art, and a further description of these devices can be omitted. Instead, the contact quenching unit 10 will be discussed in greater detail with reference to FIG. 3.

As shown in FIG. 3, the contact quenching unit 10 comprises an upper endless belt 11 serving as an upper water-retentive member, an upper driving roll 12 for driving the upper belt 11 along a circulating path, a plurality (three in the illustrated embodiment) of guide rolls 13 for guiding the upper belt 11, an upper water tank 14 serving as an upper water supply means or device and disposed along an upper run of the endless upper belt 11 so as to receive part of the upper endless belt 11 while the belt 11 is circulating, a plurality (two in the illustrated embodiment) of additional guide rolls 15 for guiding the upper endless belt 11 to move across cooling water held in the upper water tank 14, an upper presser member 16 for depressing an upper surface of the upper endless belt 11, a multiplicity of holes or apertures 17 formed in the presser member 16, an upper unit body 18 integrally mounted to an upper surface of the presser member 16, a series of degassing chambers 19 formed in the upper unit body 18, and a series of moisturizing chambers 21 formed in the upper unit body 18 in alternating relation to the degassing chambers 19, a vent pipe 22 drawn from the respective degassing chambers 19, a suction blower 23 connected with the vent pipe 22 and serving as a degassing means or device, a plurality of water-dropping pipes (water supply ducts) 24 disposed inside the respective moisturizing chambers 21, and a pair of air spray nozzles 25 serving as an excess water removing means or device for removing excess water from the upper endless belt 11.

The contact quenching unit 10 also comprises a lower endless belt 31 serving as a lower water-retentive member disposed below the upper endless belt 11, a lower driving roll 32 for driving the lower belt 31 along a circulating path, a plurality (three in the illustrated embodiment) of guide rolls 33 for guiding the lower belt 31, a lower water tank 34 serving as a lower water supply means or device and disposed along a lower run of the lower endless belt 31 so as to receive part of the lower endless belt 31 while the belt 31 is circulating, a plurality (two in the illustrated embodiment) of additional guide rolls 35 for guiding the lower endless belt 31 to move across cooling water held in the lower water tank 34, a lower presser member 36 for supporting a lower surface of the lower endless belt 31, a multiplicity of holes or apertures 37 formed in the presser member 36, a lower unit body 38 integrally mounted to a lower surface of the presser member 36, a series of degassing chambers 39 formed in the lower unit body 38, and a series of moisturizing chambers 41 formed in the lower unit body 38 in alternating relation to the degassing chambers 39, a vent pipe 42 drawn from the respective degassing chambers 39, a suction blower 43 connected with the vent pipe 42 and serving as a degassing means or device, a plurality of water-supply nozzles 44 disposed inside the respective moisturizing chambers 41, and a pair of air spray nozzles 45 serving as an excess water removing means or device for removing excess water from the lower endless belt 31.

The degassing devices should by no means be limited to the suction blowers 43, 43 as in the illustrated embodiment but may include an ejector pump or a vacuum pump.

The upper and lower belts 11, 31 may be made of any of felts, woven fabrics or meshes of a heat-resistant material. The heat-resistant material preferably comprises organic fibers such as represented by aramid fibers, metal fibers such as represented by stainless steel fibers, and ceramic fibers such as represented by glass fibers.

Thicker felts are favorable for more uniformly quenching the glass sheet being processed, and increase the initial water content thereof to a higher degree. For effectively discharging the water vapor to be generated through contact with the glass sheet, thinner felts are more preferred for the belts. As receiving great tension in a drive direction while being driven, the belts may preferably be base canvas-reinforced felts.

The belts 11, 31 may also be plain-woven or twill-woven fabrics which are resistant to a tensile force. The weave texture of the woven fabrics shall be determined in consideration of the quenching uniformity and water retentiveness thereof.

In the case of the meshes, mesh patterns may be selected with consideration given to the quenching uniformity and water retentiveness thereof. When higher degrees of quenching uniformity and water retentiveness are desired, the meshes may be used in combination with the felts to form a hybrid belt.

The contact quenching unit 10 of the foregoing construction will operate as follows.

In FIG. 3, the upper and lower driving rolls 12, 32 are rotated by some driving sources (e.g., motors, not shown), whereby the upper endless belt 11 is circulated counterclockwise in FIG. 3 and the lower belt 31 is circulated clockwise. While the upper and lower belts 11, 31 are thus dipped or immersed in water in the upper and lower water tanks 14, 34, respectively, they are cooled therein and absorb water. Thereafter, the upper and lower belts 11, 31 pass between the air spray nozzles 25, 25, 45, 45, and then pass between the upper and lower presser members 16, 36 along with a glass sheet 27 sandwiched between the belts 11 and 31. In this process, the glass sheet 27 is forcedly cooled or quenched by the water-retentive upper and lower belts 11, 31 both retaining water therein.

The upper and lower water tanks 14, 34 have the function of cooling the upper and lower belts 11, 31 that have absorbed heat and have been heated, to thereby restore the belts to their original condition. Specifically, the function of the tanks 14, 34 is that they cool the upper and lower belts 11, 31 to a predetermined temperature while supplying them with plenty of water necessary for cooling or quenching the glass sheet 27. By thus restoring the predetermined original condition, the upper and lower belts 11, 31 start to forcedly cool or quench the glass sheet 27.

FIG. 4 shows on enlarged scale a part of the upper and lower unit bodies 18, 38. A part of water absorbed by the upper and lower belts 11, 31 evaporates and takes away the heat from the upper and lower surfaces of the glass sheet 27. The water vapor or steam thus generated is discharged out of the units 18, 38 through the holes or perforations 17, 37 and through the degassing chambers 19, 39, as in the arrowed direction. Accordingly, there is no risk of some excess water vapor or steam remaining on the upper and lower surfaces of the glass sheet 27. If, contrary to this, some excess water vapor or steam remains on the glass sheet 27, it will form a heat-insulating layer that interferes with heat conduction, and, if so, the apparatus could not enjoy the intended quenching performance. Forcedly removing the water vapor or stream as herein enables the apparatus to well continue the desired forced cooling of the glass sheet 27.

In this embodiment, the water vapor or steam is discharged outside in the upper or lower direction through the degassing chambers 19, 39. Apart from this, it may also be discharged outside in the front or back direction in FIG. 4. The degassing chambers 19, 39 may be those in which the internal pressure is kept strictly negative (that is, reduced pressure lower than atmospheric pressure), but may also be those that merely act as exhaust passageways.

Through evaporation, the water content of the upper and lower belts 11, 31 decreases. Therefore, water is supplied to the upper belt 11 through the water-dropping ducts 24, and to the lower belt 31 through the water spray nozzles 44. This ensures continuous forced cooling of the glass sheet in good condition in the forced cooling apparatus.

As thus for explained, at a first stage of quenching, the glass sheet 27 is rapidly cooled or quenched by the air-quench unit 9 with cooling power or capacity which is not extremely high. A tensile stress temporarily created on the glass sheet surface at the initial stage of quenching can be, therefore, limited to the extent that breakage does not occur in the glass sheet. Thus, the glass sheet breakage at the initial stage of quenching can be avoided.

At a second stage of quenching which is achieved by the contact quenching unit 10, the water-retentive members wetted with water, such as circulating endless upper and lower fabric belts 11, 31 suitably wetted with water, are bought into contact with the opposite surfaces of the glass sheet to thereby quench the glass sheet surfaces. In this instance, a part of water retained in the water-retentive members 11, 31 evaporates owing to the heat of the glass sheet, and the glass sheet is thereby effectively cooled by the heat of evaporation of that water. As a result, even thin glass sheet that may hardly have a temperature difference between the center and the surface thereof during quenching can be effectively tempered. Furthermore, a higher level of toughness can be imparted to the glass sheets thicker than 3.0 mm.

FIG. 5 is a detailed view, with parts shown in cross section, of the contact quenching unit 55 of the forced cooling apparatus 2 according to a second embodiment shown in FIG. 1B. The contact quenching unit 55 is equipped with upper and lower water-retentive members taking in the form of rolls.

In the contact quenching unit 55, the upper and lower water-retentive members comprise a number of upper and lower felt rolls 60, 61 each composed of a felt 59 wound around a shaft 58. Water drops from the respective water-dropping ducts 24 are applied to the upper felt rolls 60 via the respective intermediate rolls 62, and the water content of the upper felt rolls 60 is thereby suitably controlled. Lower small water tanks 63 are disposed below a path of a glass sheet 27. Water held in these lower small water tanks 63 is applied to the respective lower felt rolls 61 via the respective intermediate rolls 64, and the water content of the lower felt rolls 61 is thereby suitably controlled. The water vapor formed on an upper surface of the glass sheet 27 is forcedly discharged outside through degassing chambers 19 each disposed between two adjacent ones of the upper felt rolls 60, 60, and through a vent pipe 22 and a suction blower 23. The water vapor formed on a lower surface of the glass sheet 27 is forcedly discharged outside through the degassing chambers 39 disposed between the adjacent lower felt rolls 61, 61. Water is supplied to the lower small water tanks 63 through the water supply pipe or duct 65, and its overflow is taken out through the overflow pipe or duct 66. In that manner, the water level in every water tank 63 is kept all the time constant.

As described previously with reference to FIG. 1B, the contact quenching unit 55 equipped with water-retentive quenching rolls 60, 61 is disposed downstream of the air-quench unit 9 so as to form the forced cooling apparatus 2. In the forced cooling apparatus 2, the air-quench unit 9 is designed to conduct a first stage of quenching according to the air-quench process with cooling capacity which is not extremely high. This ensures that a tensile stress temporarily created on the glass sheet surface at the initial stage of quenching can be limited to the extent that breakage does not occur in the glass sheet. Thus, the glass sheet breakage at the initial stage of quenching can be avoided.

At a second stage of quenching which is achieved by the contact quenching unit 55, the water-retentive members wetted with water, such as upper and lower felt rolls 60, 61 suitably wetted with water, are bought into contact with the opposite surfaces of the glass sheet 27 to thereby quench the glass sheet surfaces. In this instance, water held in the water-retentive members (felt rolls) 60, 61 partly evaporates owing to the heat of the glass sheet, and the glass sheet is thereby effectively cooled by the heat of evaporation of that water. As a result, even thin glass sheet that may hardly have a temperature difference between the center and the surface thereof during quenching can be effectively tempered. Furthermore, for the glass sheets thicker than 3.0 mm, a higher level of toughness can be obtained.

If desired, the upper surface of the glass sheet 27 may be quenched with the upper belt 11 as in FIG. 3, while the lower surface of the glass sheet 27 is quenched with the lower felt rolls 61 shown in FIG. 5; or the lower surface of the glass sheet may be quenched with the lower belt 31 as in FIG. 3, while the upper surface thereof is quenched with the upper felt rolls 60 shown in FIG. 5.

FIG. 6 shows in perspective a part of a contact quenching unit 75 of FIG. 1C, including an upper quenching belt 11 formed with a rectangular aperture or opening 77. Other structural details are the same as those of the contact quenching unit 55 shown in FIG. 3, and no further description thereof is needed. The size and the position of the opening 77 are optional.

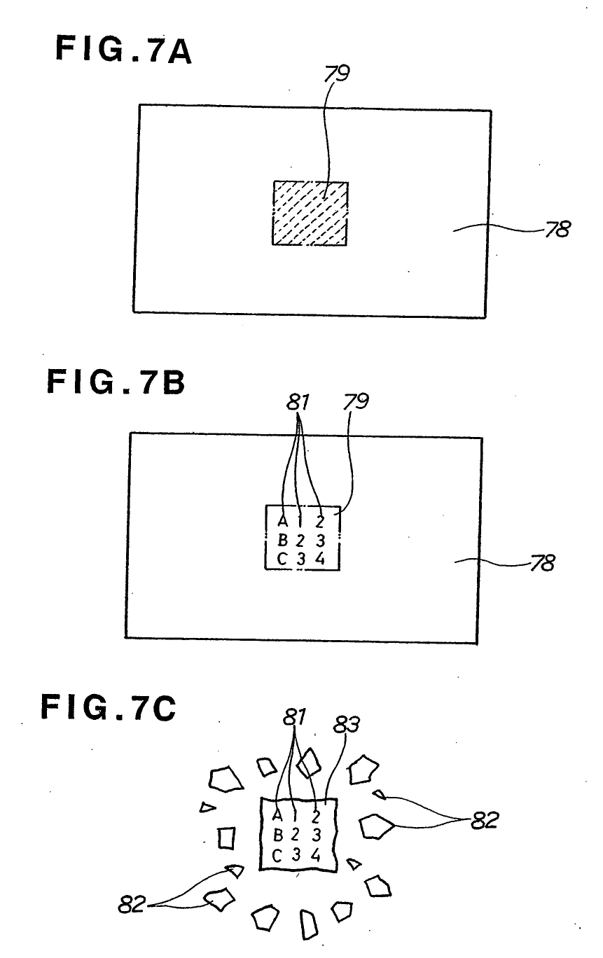

FIG. 7A diagrammatically shows a tempered glass sheet formed by using the contact quenching unit 75 equipped with the apertured water-retentive upper quenching belt 11 shown in FIG. 6. The tempered glass sheet 78 has a phantom-lined rectangular central portion 79 (indicated by the dash lines for clarity) which is less tempered than the rest of the glass sheet 78. The less-tempered portion 79 is formed due to the presence of the opening 77 in the water-retentive upper quenching belt 11 because a portion of the quenching belt 11 including the opening 77 cannot retain water and hence does not function as a part of the water-retentive quenching member which is necessary for achieving the secondary quenching process. That portion 79 of the glass sheet 78 which is brought into register with the opening 77 of the quenching belt 11 does not undergo quenching during the secondary quenching process. Thus, the sheet glass portion 79 is less tempered than the rest of the glass sheet 78 and hence has a lower level of toughness than the rest of the glass sheet 78.

In one preferred form of application shown in FIG. 7B, the less-tempered portion 79 is used to carry marks or characters which are applied after the tempering process so as to represent product information, including lot number and so on, of the tempered glass sheet 78.

The tempered glass sheet 78 will break when subjected to a force greater than a predetermined value. In this instance, all the parts except the less-tempered portion 79 (FIG. 7B) of the tempered glass sheet 78 fracture into small, relatively harmless pieces 82, as shown in FIG. 7C. The less-tempered portion 79 remains substantially unchanged in its shape and configuration even after the break of the tempered glass sheet 78.

Tempered glass has a large residual compressive stress created on the outer surfaces thereof, which gives the tempered glass an increased strength. The center of the tempered glass has a large tensile stress created to balance or cancel out the tensile stress. With this stress balancing, when breakage occurs in the tempered glass, the tensile stress promotes propagation of cracks, allowing the tempered glass as a whole to fracture into small pieces. After such fracturing, it is no longer possible to read any information from the small glass pieces even when some sorts of information are given on a surface of the tempered glass sheet.

In case of the tempered glass sheet 78 having a less-tempered portion 79 (FIG. 7A), the less-tempered portion 79 can retain its original shape and configuration when the tempered glass sheet 78 is broken. The less-tempered portion 79, when broken, will shatter into relatively large shards. As shown in FIG. 7C, a piece 83 formed from the less-tempered portion 79 is considerably larger in size than other pieces 82 and bears all of the marks or characters 81 representing product information of the tempered glass 78. Thus, the product information can be readily obtained from the marks 81 on the piece 83 and is effectively used when the broken tempered glass sheet 78 is to be replaced with a new one or when an investigation is conducted to determine the cause of the breakage.

Referring back to FIGS. 1A to 1C, the air-quench unit 9 undertakes primary quenching of the glass sheet according to the air-quench process with cooling power or capacity which is not extremely high. Therefore, a tensile force temporarily created on the glass sheet surfaces at the initial stage of quenching can be limited to the extent that breakage does not occur in the glass sheet. Thus, the glass sheet breakage at the initial stage of quenching can be avoided.

In the contact quenching unit 10, 55 or 75 for achieving a secondary quenching process, a water-retentive quenching member wetted with water, such as a fabric suitably wetted with water, is brought into contact with the outer surfaces of the glass sheet to thereby quench the outer surfaces. In this instance, water held in the water-retentive quenching member partially evaporates owing to the heat of the glass sheet, and the glass sheet is thereby effectively cooled by the heat of evaporation of that water. As a result, even thin glass sheet that may hardly have a temperature difference between the center and the surface thereof during quenching can be effectively tempered. It is also possible to impart high level of toughness to the glass sheet having a thickness larger than 3.0 mm.

The contact quenching unit 10, 55 or 75 equipped with water-retentive quenching members ensures far higher cooling performance as compared with ordinary air-quench processes or solid contact quenching processes. With the water-retentive member contact quenching unit 10, 55 or 75, therefore, even thin glass sheet having a thickness of at most 3.0 mm or less can be well tempered. Specifically, according to the water-retentive member contact quenching process of the invention, even such thin glass sheet having a thickness not greater than 3.0 mm can be well processed to produce tempered glass. In addition, the invention is also favorable even to the production of tempered glass sheet that is thicker than 3.0 mm and is therefore readily processed in an ordinary air-quench process. As compared with the ordinary air-quench unit, the water-retentive member contact quenching unit 10, 55 or 75 of the invention is compact in size and can operate with relatively low running costs.

A tempered glass sheet according to the present invention has a portion which is less tempered than the rest of the glass sheet. The less-tempered portion is preferably used to bear marks or characters representing product information of the tempered glass sheet. When the tempered glass sheet is broken, the less-tempered portion may remain substantially unchanged in its shape and configuration or may shatter into relatively large shards. Accordingly, the product information can be readily obtained from the marks or characters born on a relatively large piece or pieces departed parting from the less-tempered portion.

### INDUSTRIAL APPLICABILITY

With the arrangements so far described, the present invention can be used advantageously as forced cooling method and apparatus used for the production of a tempered thin glass sheet of high quality which is useful, for example, for vehicular windshields that are required to be lightweight. Furthermore, a tempered glass sheet having a less-tempered portion (or a portion with lower level of toughness than the rest of the glass sheet) is obtained, and it is particularly advantageous when the less-tempered portion is used to bear marks or characters indicative of product information of the tempered glass sheet.

1. A method of producing a tempered glass sheet, comprising:
a primary quenching step in which a glass sheet heated at a predetermined temperature is quenched by blasting a cooling air against opposite surfaces of the glass sheet; and
a secondary quenching step in which the glass sheet, which has been subjected to the primary quenching step, is further quenched by causing a water-retentive member to contact the opposite surfaces of the glass sheet with water retained in the water-retentive member.

2. The method according to claim 1, wherein the primary quenching step lasts for not longer than (t²/4) seconds where t is a thickness of the glass sheet.

3. A forced cooling apparatus for use in the production of a tempered glass sheet, the forced cooling apparatus comprising:
an air-quench unit for blasting cooling air against opposite surfaces of a glass sheet to quench the glass sheet, the glass sheet having been heated to a predetermined temperature; and
a contact quenching unit disposed downstream of the air-quench unit and equipped with a water-retentive member wet with water, the contact quenching unit being operative to cause the water-retentive member to contact the opposite surfaces of the glass sheet to further quench the glass sheet.

4. The forced cooling apparatus according to claim 3, wherein the contact quenching unit includes:
an upper water-retentive member and a lower water-retentive member for holding the glass sheet therebetween, the upper and lower water-retentive members being formed from a material capable of absorbing and storing water;
an upper water supply device for supplying water to the upper water-retentive member; and
a lower water supply device for supplying water to the lower water-retentive member.

5. The forced cooling apparatus according to claim 4, wherein the upper water-retentive member is an upper endless belt circulating for contact with an upper surface of the glass sheet, the lower water-retentive member is a lower endless belt circulating for contact with a lower surface of the glass sheet, the upper water supply device includes an upper water tank in which the upper belt is immersed as it travels along an upper circulating path, and the lower water supply device includes a lower water tank in which the lower belt is immersed as it travels along a lower circulating path.

6. The forced cooling apparatus according to claim 4, wherein the upper water-retentive member comprises a series of upper rolls arranged for contact with an upper surface of the glass sheet, the lower water-retentive member comprises a series of lower rolls arranged for contact with a lower surface of the glass sheet, the upper water supply device comprises a plurality of water supply pipes associated with the respective upper rolls for supplying water to the upper rolls, and a plurality of upper intermediate rolls disposed between the respective upper rolls and the respective water supply pipes and held in rolling contact with the respective upper rolls for controlling the water content of the upper rolls, and the lower water supply device comprises a plurality of water tanks disposed directly below the respective lower rolls for holding water therein, and a plurality of lower intermediate rolls partly immersed in the respective water tanks and held in rolling contact with the respective lower rolls for supplying water from the water tanks to the lower rolls while controlling the water content of the lower rolls.

7. The forced cooling apparatus according to claim 5, wherein at least one of the upper belt and the lower belt has an opening formed therein to avoid contact of the glass sheet with water held in the at least one belt to thereby form a less-tempered portion in the glass sheet.

8. A tempered glass sheet having a less-tempered portion formed by processing a glass sheet heated at a predetermined temperature on the forced cooling apparatus of claim 7.

9. The tempered glass sheet according to claim 8, wherein the less-tempered portion bears marks or characters indicative of product information of the tempered glass sheet.
